(19) United States
(12) Patent Application Publication
(10) Pub. No.: US 2016/0098524 A1
(43) Pub. Date: Apr. 7, 2016

(54) Medical inventory tracking

(71) Applicant: Stevan Himmelstein, Memphis, TN (US)

(72) Inventor: Stevan Himmelstein, Memphis, TN (US)

(21) Appl. No.: 14/871,942

(22) Filed: Sep. 30, 2015

Related U.S. Application Data
(60) Provisional application No. 62/058,637, filed on Oct. 1, 2014.

(51) Int. Cl. G06F 19/00

(52) U.S. Cl. CPC G06F 19/327

(57) ABSTRACT

Managing inventory and providing robust analytics related to the use of such inventory. In one embodiment a system is provided that includes terminals for collecting information about one or more medical consumables in a medical setting, an inventory tracker for processing and storing the information about the one or more medical consumables and making inventory information about the medical consumables available, and an analytics engine for generating usage information about a medical consumable within the medical setting.

### CROSS-REFERENCE TO RELATED APPLICATIONS

This application claims priority to and the benefit of U.S. Provisional Patent Application No. 62/058,637, filed on Oct. 1, 2014, which is hereby incorporated herein by reference in its entirety.

### TECHNICAL FIELD

Embodiments of the invention generally relate to inventory control, tracking, and exchange, and more specifically to managing inventory of medical consumables through robust analytics.

### BACKGROUND

Escalating healthcare costs require aggressive and creative financial management from hospitals and medical device manufacturers to remain profitable. Two high cost items with short shelf lives are pharmaceuticals and medical devices. Currently, medical devices and pharmaceuticals are required to carry an expiration date to prevent the use of degraded, ineffective, or even harmful items.

Extensive resources are required to manage these items and ensure that they remain within their expiration date. Frequently, hospital staff or device company representatives perform physical counts of products on a shelf to determine total devices available and to check their expiration dates. Items that are used slowly or close to their expiration date may be discarded and replaced with items whose expiration date may be further out. Significant manpower is required to perform these menial tasks at notable expense to both hospitals and manufacturers.

Manufacturers and suppliers of items rely on the purchase orders, forecasts prepared by the customer, or word of mouth form onsite visits to estimate a facility's demand for an item. The information provided may be inconsistent. A supplier rarely knows if items were used, expired, discarded, or sold as excess. In the case of practices or care settings where there are a large number of physicians, unless the supplier is present during a procedure or clinic visit, the supplier will not know which physician used the item. If a customer has a centralized purchasing department (such as a large integrated healthcare network), items may be warehoused and then moved to facilities as needed. Again, unless the supplier is present during the procedure or clinic visit, the supplier will not know which facility used their products.

Appropriate management of these items and their expiration dates is important to prevent inventory waste and reduced profits.

### SUMMARY

In general, various aspects of the systems, methods, and apparatus described herein are directed toward an inventory tracking system that tracks medical consumables utilizing quantitative analysis for improved demand forecasting, facilitates redistribution of the consumables, and facilitates targeted marketing based on the quantitative analysis.

According to one aspect of the present invention a system for tracking resource usage in a medical setting is provided. The system includes a terminal that is configured to receive information about at least one medical consumable from an input device; an inventory tracker that is configured to receive information about the at least one medical consumable from the terminal, update inventory information about the at least one medical consumable stored in computer readable memory, and generate an inventory report based on the inventory information; and an analytics engine that is configured to receive the inventory information, process the inventory information to generate usage information about the at least one medical consumable, and generate a usage report based on the usage information.

In one embodiment, the information about the at least one medical consumable comprises at least one or more of manufacturer identity, the item name, item size, date of arrival, date of use, date of expiration, site usage, prescribing physician, facility name, and combinations thereof.

In another embodiment, the usage information is at least one of product specific, facility specific, or physician specific.

In another embodiment, the usage information comprises at least one of a forecasted demand for the medical consumable, historical demand for the medical consumable, a number of medical consumables used during a defined period, a number of medical consumable expired during a defined period, a number of medical consumables sold during a defined period, and combinations thereof.

In another embodiment, the usage report is a graphical representation of the usage information.

In another embodiment, the analytics engine is configured to receive category usage information about the at least one medical consumable and generate the usage report based at least in part on the category usage information.

In another embodiment, the input device comprises at least one of a smartphone, tablet, desktop, radio frequency identifier reader, barcode reader, or combinations thereof.

In another embodiment, the analytics engine makes available the usage information to one or more subscribers.

In another embodiment, the subscribers may be one or more of a manufacturer, a distributor, a hospital administrator, a physician, and a financial analyst.

In another embodiment, the system for tracking resource usage in a medical setting may include an exchange that is configured to list the at least one medical consumable for consumption by a third party based at least in part on information received from the inventory tracker.

In another embodiment, the inventory tracker updates inventory information about the at least one medical consumable based on a notice from the exchange indicating a transaction associated with the medical consumable.

In another embodiment, the system for tracking resource usage in a medical setting may include an advertisement manager that is configured to receive the usage information, receive advertising content, and transmit the advertising content to one or more marketing targets based on criteria provided by an advertiser and associated with one or more profiles generated from the usage information.

In another embodiment, one or more of the inventory tracker and the terminal is configured to present the advertising content.

According to another aspect of the present invention, a computer implemented method of for tracking resource usage in a medical setting is provided. The method includes collecting information about at least one medical consumable; updating inventory information stored in computer readable memory about the at least one medical consumable based on the collected information; generating, by a computer, usage information about the at least one medical consumable based on the inventory information; and generating, by a computer, a usage report based on the usage information.

In one embodiment, the information about the at least one medical consumable comprises at least one or more of manufacturer identity, resource name, resource size, date of arrival, date of use, date of expiration, site usage, prescribing physician, facility name, and combinations thereof.

In another embodiment, the usage information is at least one of product specific, facility specific, or physician specific.

In another embodiment, the usage information comprises at least one of a forecasted demand for the medical consumable, historical demand for the medical consumable, a number of medical consumables used during a defined period, a number of medical consumables expired during a defined period, a number of medical consumables sold during a defined period, and combinations thereof.

In another embodiment, the usage report is a graphical representation of the usage information.

In another embodiment, the computer implemented method includes receiving category usage information about the at least one medical consumable and generate the usage report based at least in part on the category usage information.

In another embodiment, the computer implemented method includes making the usage report available to one or more subscribers.

According to another aspect of the present invention, a computer implemented method for providing targeted advertising in a medical setting is provided. The method includes receiving usage information associated with at least one user's use of at least one medical consumable; generating, by a computer, at least one profile based on the usage information and storing the profile in computer readable memory; receiving advertising content and criteria associated with a marketing target; and facilitating display of the content to one or more users based on a match, determined at least in part by a computer, between the profile associated with the user and the criteria.

The foregoing and other features and advantages of the present invention will be made more apparent from the descriptions, drawings, and claims that follow. One of ordinary skill in the art, based on this disclosure, would understand that other aspects and advantages of the present invention exist.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 illustrates a system for tracking medical consumables according to an exemplary embodiment of the invention;

FIG.2 illustrates a process for tracking medical consumables according to an exemplary embodiment;

FIG. 3 illustrates an analytics engine for facilitating generation of usage information according to an exemplary embodiment;

FIG. 4 illustrates a process for the operation of an analytics engine to generate usage information according to an exemplary embodiment;

FIG. 5 illustrates an medical consumables exchange system according to an exemplary embodiment of the invention;

FIG. 6 illustrates a process for transacting medical consumables according to an exemplary embodiment of the invention;

FIG. 7 illustrates a system for targeted marketing according to an exemplary embodiment of the present invention.

FIG. 8 illustrates a process for targeted marketing according to an exemplary embodiment of the present invention.

### DETAILED DESCRIPTION

Described herein are various embodiments of methods and systems consistent with the present invention. These embodiments are exemplary and should not be interpreted to limit the scope that one of ordinary skill in the art would give to the invention. In some instances, well-known operations are not described in detail to avoid unnecessarily obscuring the present invention.

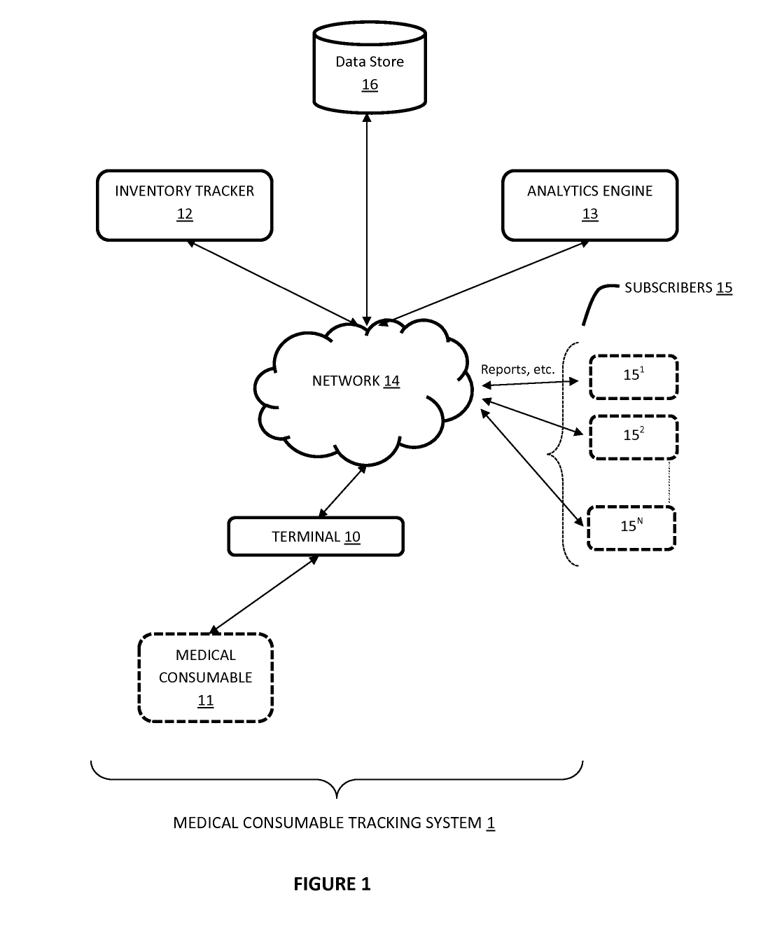

FIG. 1 illustrates an exemplary embodiment of a Medical Consumable Tracking System 1 in accord with the present invention. The Medical Consumable Tracking System 1 includes one or more Terminals 10, Inventory Tracker 12, Data Store 16, Analytics Engine 13, and Network 14. FIG. 1 also includes Medical Consumables 11 and Subscribers 15, which are not part of the present invention, but are illustrated for convenience when describing System 1. Typically, Medical Consumables 11 are controlled by a medical facility or practice, and Subscribers 15 are third parties that have access to the information managed by the Inventory Tracker 12 and/or Analytics Engine 13.

In one embodiment, Terminal(s) 10 are distributed around a medical setting. The medical setting where the Terminal(s) 10 are located may be a hospital, clinic, private office, emergency room or urgent care facility, mobile health unit, ambulance or other facility that uses medical products. The Terminal(s) 10 are operable to collect inventory information about the Medical Consumables 11. Inventory information is any medical consumable related information, including the manufacturer, item name, item size, date of arrival, date of use, date of expiration, site usage, prescribing physician, facility name, and combinations thereof. Inventory information may also include derivatives of the medical consumable related information, such as quantities of one or more medical consumables available within a medical setting.

The Terminal 10 may take a variety of forms, such as a desktop computer, laptop, or a kiosk that incorporates the same. Handheld devices are also supported, for example PDAs, smartphones, tablets, phablets, programmable consumer electronics, bar code scanners, or similar devices that allow for the input of information. Each Terminal 10 includes at least a mechanism for the entry of information about the medical consumables tracked by the Inventory Tracker 12. The information may be input using manual methods, e.g., an operator may enter the data using a smartphone, tablet, desktop computer. In another embodiment the information may be input using automated methods (e.g., an RFID reader scanning an RFID tag, a bar code reader or camera scanning a visual marker), semi-automated methods, e.g., a reader that scans a tag containing some or all of the data or a reference to an external record in a database containing some or all of data. Some embodiments may utilize a combination of these data entry methods, e.g., with an operator scanning a code containing the item name, manufacturer, and size and manually operating an app on the scanner to enter the associated expiration date.

Input may be accomplished by devices such as a keypad, a keyboard, a scanner, a camera, an RFID reader, a pointing device (e.g., a mouse) etc. Other supported input devices may include a microphone, joystick, game pad, satellite dish, scanner, voice recognition device, touch screen, toggle switch, pushbutton, or the like. These and other input devices are often connected to a processing unit through a user input interface, such as a parallel port, game port, universal serial bus (USB). The input devices may also interface with the Terminal 10 via a wireless interface such as an 802.11a/b/g/n (Wi-Fi) interface, Bluetooth, or near field communication.

The medical consumable, which may be referred to herein generically as an “item” or “items,” may be any medical product or set of products used for therapeutic or interventional purposes that is not reusable, has a limited number of uses before it has to be replaced, or expires after some period of time (either because it has an associated expiration date or its efficacy or usefulness is known to be reduced). By way of non-limiting examples, medical consumables may be drugs, medical devices, gels, materials such as bandages and gloves, etc.

Inventory Tracker 12 and Analytics Engine 13 may be special purpose hardware, special purpose software running on general purpose hardware, or some combination thereof, that operates on or communicates over Network 14 with various elements of System 1. In one exemplary embodiment, Inventory Tracker 12 and Analytics Engine 13 are servers on a local network. They may also reside on “on the cloud,” for example hosted computing services offered by Amazon Web Services.

In one embodiment the Inventory Tracker 12 is operable to receive inventory information from the Terminal(s) 10, process that inventory information, transfer it for storage at the Data Store 16, retrieve information stored on the Data Store 16, and generate and send reports based on the inventory information.

In one embodiment the Inventory Tracker 12 receives commands to generate reports. The commands may include certain criteria and format requirements for the report. In another embodiment, the Inventory Tracker 12 sends reports automatically according to predefined criteria, such as over regular intervals (e.g., every 24 hours) or upon the satisfaction of a trigger (e.g., after an item is used or an expiration is imminent). The reports may be any means of presenting or displaying information to a user (or a computer). It could be in a document format (e.g., .doc, .xls, .pdf, .rtf, .txt, .pdf, etc.), it could be graphs, tables, or visual depictions on a screen via a dashboard or portal, or it could be data without format or structure that can be processed by the recipient. In one embodiment of the present invention the Inventory Tracker 12 sends an e-mail to a manufacturer's inventory department, a sales representative, a hospital administrator, etc. If triggered by a usage event, the e-mail communication may include some or all of the details concerning the usage event or it may contain a reference to an external record containing some or all of that information.

The Analytics Engine 13 has the functional capacity to provide a collection of quantitative information concerning the how, what, and when of product usage (e.g., supply and demand curves) within a facility, a health delivery network, and by a specific physician. Embodiments of the Analytics Engine 13 include comprehensive analytics and visualization tools that provide features such as pricing transparency, supply-side inventory management capability, demand and price forecasting, real time purchases, etc., to improve micro- and macro-level decisions.

The information generated by the Analytics Engine 13 is referred to herein as, “usage information.” Usage information about the medical consumable is information that is determined through historical and predictive analytics using the inventory information, for example, to help suppliers better project future needs of the market and adjust production to meet projections. Demand and pricing, both historical and forecasted, may be determined. The usage information may be used to plan future delivery dates, recommend inter-location transfers, etc. It can also provide insight into overall global demand, as well as influencing pricing models and strategies. The availability of usage information may reduce inventory costs (for example by improving inventory turnover) for medical settings and create more certainty for suppliers. The types of models that may be used in embodiment of the Analytics Engine 13 include economic order quantity, optimal stock cycle length, variable cost per unit, optimal value of variable cost per unit time, total cost per unit time, change of variable costs, reorder level, trend analysis, and similar such models. Custom models may also be loaded into, and utilized by, the Analytics Engine 13.

In one embodiment the Analytics Engine 13 may receive and utilize category usage information. Category usage information is usage information and data for a range of products broader than the specific medical consumable being used. This includes information about the range of medical consumables as they are being used in other facilities or by other physicians. This information can be used to paint a broader picture of how types of medical consumable are being used, and global demand generally.

The Analytics Engine 13 is operable to generate and send usage reports to, for example, the Subscribers 15. Like the inventory reports generated by the Inventory Tracker 12, the usage report may use any means of presenting or displaying information to a user or a computer. For example, the usage information could be a document, a visualization of the data on a screen, or raw data to be consumed by a computer for further processing. The flexibility facilitates wider appeal for the usage data, including to manufacturers, suppliers, distributors, hospitals administrators, and even financial analysts on Wall Street.

The Data Store(s) 16 serves as a repository for entered item data, including inventory information. The Data Store 16 allows for interrogation of the data stored therein, including the inventory information, by the Inventory Tracker 12 and facilitates the generation of various reports.

The Data Store 16 may be located on-site at the facility, at another medical facility or management facility, or at a third-party offering cloud computing services (e.g., Amazon Web Services, Google Cloud Computing, etc.). Data Store 16 may comprise a single database or a collection of databases, dedicated or otherwise. Data Store 16 may be a searchable database and may comprise, include, or interface to a relational database or NoSQL database (such as Cassandra NoSQL). Other databases, such as a query format database, a Structured Query Language (SQL) database, a storage area network (SAN), or another similar data storage device, query format, platform or resource may be used.

In one embodiment, Data Store 16 may cooperate with other databases to store the various data and information described herein. In some embodiments, Data Store 16 may comprise a file management system, program or application for storing and maintaining data and information used or generated by the various features and functions of the systems and methods described herein.

In this exemplary embodiment, the Network 14 facilitates communication and transfer of information by and among Terminals 10, Inventory Tracker 12, Data Store 16, and Analytics Engine 13. As described above, in some embodiments that Terminals 10, Inventory Tracker 12, Data Store 16, and Analytics Engine 13 may reside, in various combinations, in a single computer or server, but also may be separate and remote from each other.

The Network 14 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

Network 14 may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link.

In some embodiments, Network 14 may comprise a satellite communications network; such as a direct broadcast communication system (DBS) having the requisite number of dishes, satellites and transmitter/receiver boxes, for example. Network 14 may also comprise a telephone communications network, such as the Public Switched Telephone Network (PSTN). In another embodiment, Network 14 may comprise a Personal Branch Exchange (PBX), which may further connect to the PSTN.

By way of the Network 14, information about medical consumables, inventory information, usage information, and reports may be transferred, by, to and among the various elements of System 1, including the Subscribers 15.

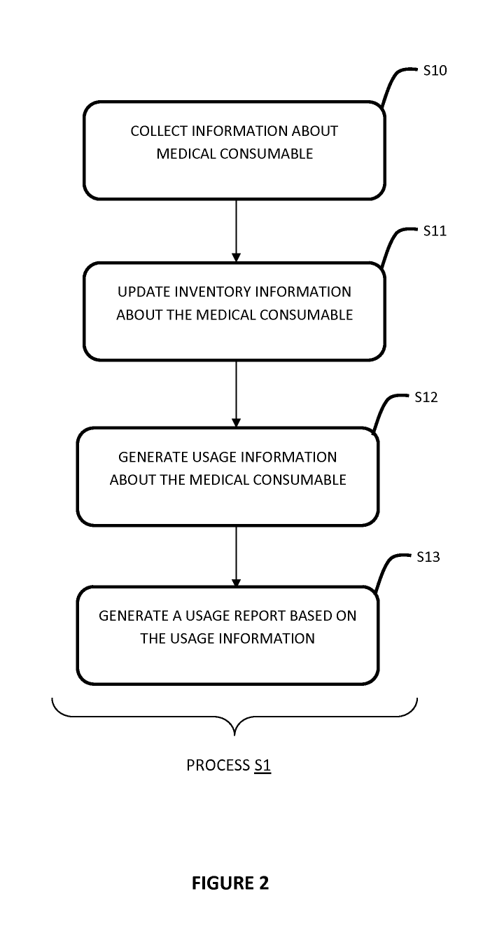

An exemplary process 51 for generating usage information is described in FIG. 2 with reference to the Inventory Tracking System 1 described in FIG. 1. First, information is collected about one or more Medical Consumables 11 (Step S10). The information is collected at the Terminals (10) and then sent to the Inventory Tracker 12.

The Inventory Tracker 12 updates the inventory information about the Medical Consumables 11 stored at the Data Store 16. (Step S11) If no record exists for the Medical Consumables 11, then a record is created and stored at the Data Store 16.

Next, the Analytics Engine 13 generates usage information about the medical consumable, based, in part, on the inventory information (Step S12). The Analytics Engine 13 may generate the usage information automatically or in response to a command.

After generating the usage information, the Analytics Engine 13 generates a usage report (Step S13). If certain criteria were defined in the command or by the automatic policy then they will be reflected in the usage report.

In one embodiment, the Analytics Engine 13 uses a publish/subscribe model for sending the usage reports. Each Subscriber 15 “subscribes” to a feed generated by the Analytics Engine 13, and filtered according to criteria defined by each Subscriber 15.

If a healthcare facility receives the usage report, the report permits the facility to, e.g., understand its supply and demand for the products it uses, providing the purchasing group with the ability to assess the facility's inventory requirements for medical devices or drugs.

If a supplier receives the usage report, the report provides, e.g., demand and price forecasting that permits suppliers to view a graphical depiction of the demand for a given product.

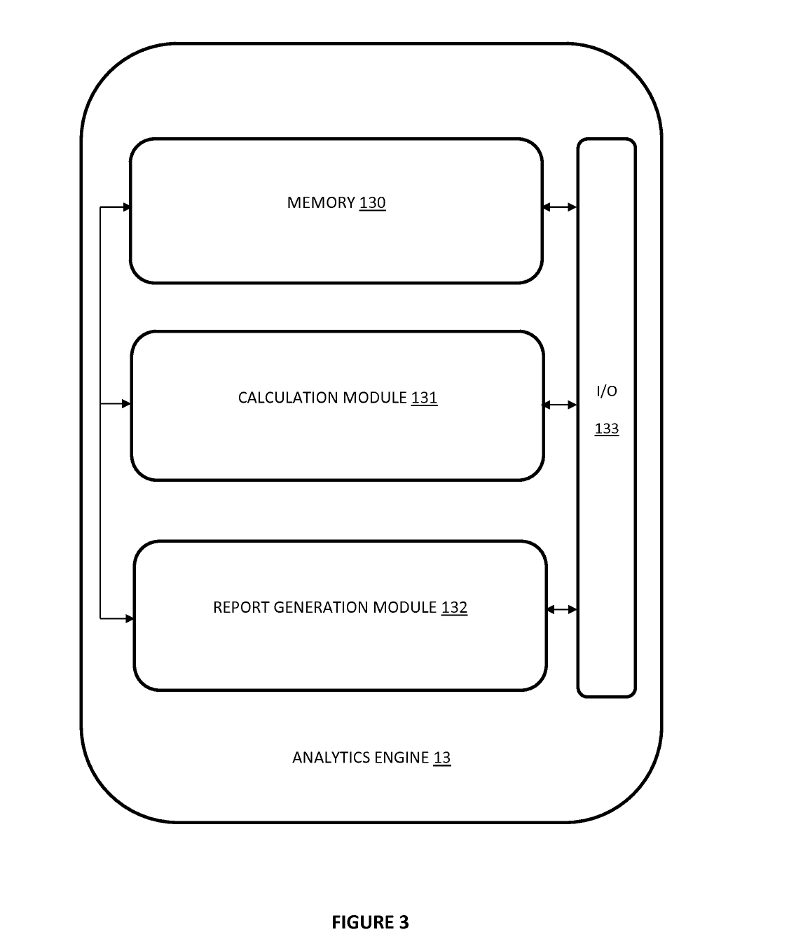

FIG. 3 illustrates an exemplary embodiment of an Analytics Engine 13 in accord with the present invention. The Analytics Engine 13 includes a Memory 130, a Calculation Module 131, a Report Generation Module 132, and an Input/output (I/O) module 133. The Memory 130 may be comprised of both long term and short term storage, and in one embodiment stores the various models used to generate the usage information as well as the usage information itself. The Calculation Module 131 can determine the usage information based on the inventory information received from the Inventory Tracker 12 via the I/O module 133. The Report Generation Module 132 is operable to generate the aforementioned usage reports. The I/O module 133 manages external communications, for example to the Inventory Tracker 12 or the Subscribers 15.

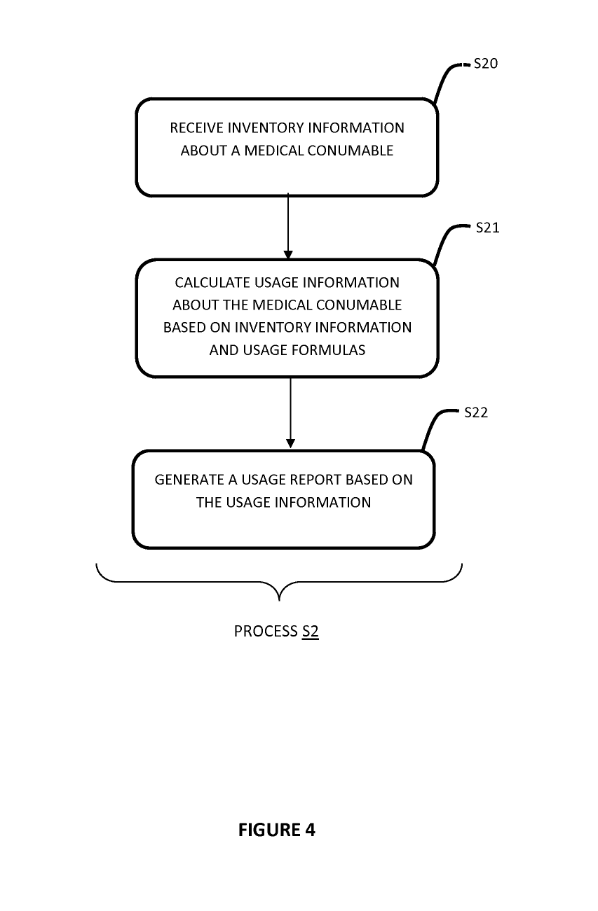

An exemplary process S2 of the operation of the Analytics Engine 13 is described in FIG. 4 with reference to the Inventory Tracking System 1 described in FIG. 1. First, the Analytics Engine 13 receives inventory information about a medical consumable (Step S20). In one embodiment the Analytics Engine 13 also receives a command with criteria for a usage report. The command may originate with a user, the Inventory Tracker 12, or some other source. In another embodiment the Analytics Engine 13 may generate usage reports automatically according to a defined protocol. Calculation Module 131 calculates usage information about the medical consumable based on the received inventory information and the formulas and models stored in the Memory 130 (Step S21). In one embodiment criteria are provided that defines if the usage information should be physician specific, facility specific, and/or healthcare network specific. By defining the level of granularity, a user is able to view demand/forecasting information for a physician, a facility, or for an entire healthcare delivery network.

In one embodiment, the Analytics Engine 13 receives category usage information. Category usage information is usage information related to a medical consumable but outside the particular medical setting of the medical consumable. For example, if analytics are being generated for a drug, the Analytics Engine 13 may receive usage information for that drug from other medical settings. This provides suppliers and administrators with more robust information about demand and pricing. In particular, administrators can see how their medical facility use of the drug compares to other facilities. This will provide insights into the kinds of services offered at other medical facilities as well as shed light on best inventory management practices.

In one embodiment the category information is shared peer-to-peer by the Analytics Engine 13 at each medical setting. In another embodiment, the usage information is aggregated at a central server (or servers) and then disseminated to one or more Analytic Engines 13.

The Analytics Engine 13 generates a usage report based on the usage information (Step S22). As described above, the usage report may be any means of presenting or displaying information to a user or a computer (e.g., a document, a dashboard, a portal, raw data, etc.).

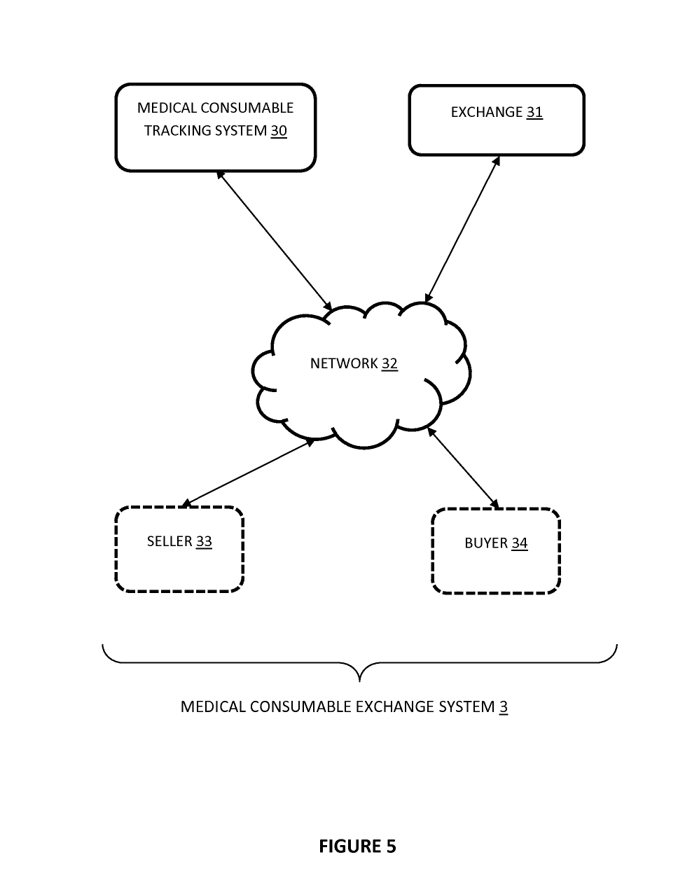

FIG. 5 illustrates an exemplary embodiment of a Medical Consumable Exchange System 3 in accord with the present invention. The Medical Consumable Exchange System 3 includes an Exchange 31, a Medical Consumable Tracking System 30, and a Network 32. In one embodiment the Medical Consumable Tracking System 30 is the Medical Consumable Tracking System 1 described in FIG. 1. FIG. 5 also includes Seller 33 and Buyer 34, which are not part of the present invention but are illustrated for convenience when describing System 3.

The Exchange 31 is a marketplace for medical consumables. It permits the listing, physical or virtual, of a new, existing, or expiring item for sale to facilitate subsequent dispatch to the purchasing facility. The Exchange 31 can be integrated into an inventory system, such as the Inventory Tracker 12 (FIG. 1), and in this embodiment described herein interfaces with the Medical Consumable Tracking System 30, so that a purchase from the Exchange 31 is entered directly into the facility's inventory system. In addition to real-time inventory information, information gleaned from the Exchange 31 can be used by the Analytics Engine 13 (FIG. 1). Further, the Exchange 31 gives the purchasing group power to make real-time decisions without having to go through third parties, such as group purchasing organizations or consultants. Ultimately, this information, as well as reimbursement (DRG) information may be tied to a real-time profit and loss statement to evaluate each decision's impact on the profitability of the business.

The Exchange 31 can be centralized, in the cloud (offered as a service), or peer-to-peer with nodes at each facility and interconnected by the Network 32.

The Network 32 facilitates communication among the elements of the Medical Consumable Exchange System 3 in the manner described above with reference to Network 14.

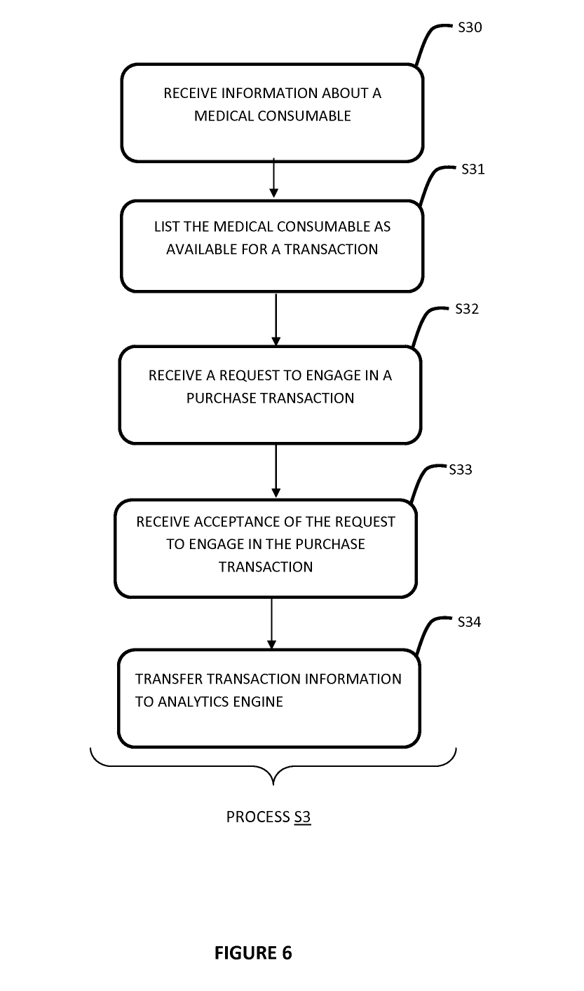

An exemplary process S3 of the operation of the Medical Consumable Exchange System 3 is described in FIG. 6.

This process begins when the Exchange 31 receives information about a medical consumable to be listed for sale (Step S30). In one embodiment the seller facility lists inventory that may be expiring but is still immediately usable according to a defined policy. In another embodiment the medical consumable is listed manually, e.g., by an administrator or operations manager with responsibility for inventory.

In one embodiment sellers and buyers can see the bid/ask prices across multiple facilities on the Exchange 31. For a facility that has had unusually high demand for a particular item, that facility can use their IMS to access inventory that may be expiring but is still immediately usable and offered by another facility on the same or lower-cost as a distributor or the facilities normal vendor.

Once the medical consumable has been listed, the seller and buyer can utilize the normal vendor sales channel as well as a hospital-to-hospital bid process to access inventory, and a more direct-to-business communication network.

Next the Exchange 31 receives a request to engage in a purchase transaction, e.g., an offer to buy (Step S32). The request/offer may have criteria associated with it. In one embodiment the seller and potential buyer communicate about the offer via an internal communication system in the Exchange 31.

The Exchange 31 receives notice that the request to engage in a purchase transaction (the offer) has been accepted (Step S33), and updates the listing. In one embodiment the Exchange 31 may have a payment system incorporated therein to facilitate the transfer of funds between the buyer and the seller.

Upon completion of the transaction the Exchange 31 stores information about the transaction and sends it to the inventory tracker and the analytics engine that is part of the Medical Consumable Tracking System 30. In one embodiment Exchange 31 can offer historical data showing aggregated demand and quantities sought at different times of the year. This data can be helpful to suppliers to better project the future needs of the market and adjust their own production in line with these projections. An analytics engine may, for example, incorporate current pricing information into the demand analysis. The seller's inventory tracker may update information about the sold medical consumable in the internal system.

Embodiments featuring the Exchange 31 enable a supplier to actively manage its inventory by offering the supplier's inventory at a discount to market price and finding immediate buyers for that inventory.

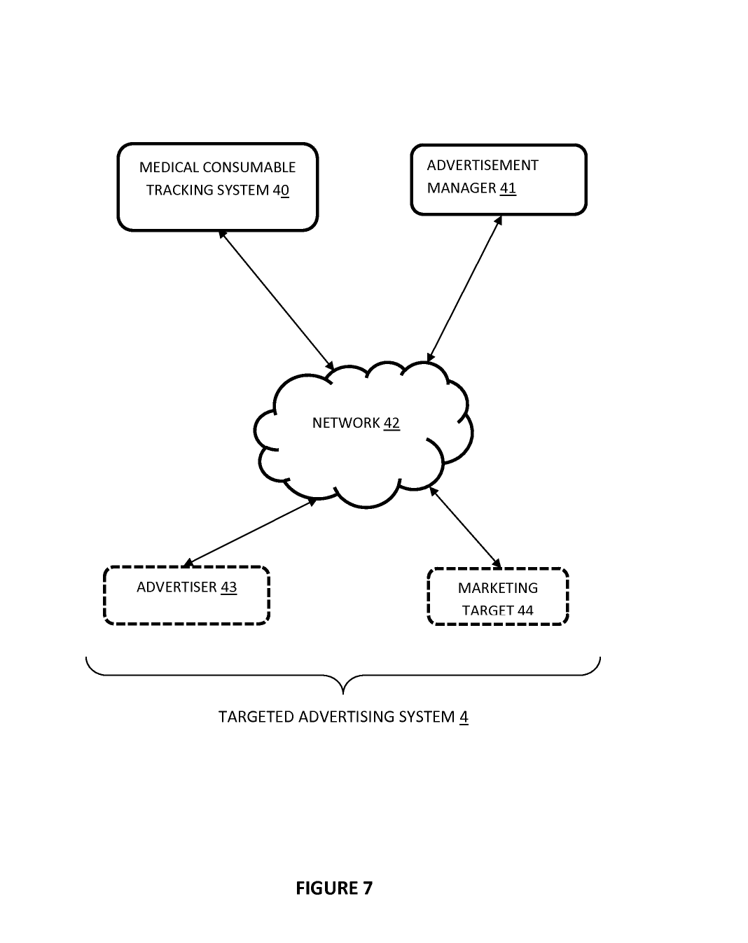

FIG. 7 illustrates an exemplary embodiment of a Targeted Advertising System 4, in accord with the present invention. The Targeted Advertising System 4 includes a Medical Consumable Tracking System 40, an Advertisement Manager 41, and a Network 42. Also illustrated are an Advertiser 43 and a Marketing Target 44, which are illustrated for convenience but are not part of the present invention.

The Medical Consumable Tracking System 40 may be the System 1 described in FIG. 1. It is in communication with the Advertisement Manager 41 via the Network 42. The Network 42 facilitates communication among the elements of the System 4, and operates in a similar manner to Network 14 (FIG. 1). The Medical Consumable Tracking System 40 may be one of a plurality of such systems that communicates with the Advertisement Manager 41. The Medical Consumable Tracking System 40 is operable to send information to the Advertisement Manager 41, including usage information. The Advertisement Manager 41 is operable to use the information to generate marketing profiles for the various individuals and entities interacting with the system containing various relevant information. For example, practice, products, size, demand over time, etc. These profiles can be matched to marketing criteria to send targeted advertising to the various individuals and entities interacting with the system.

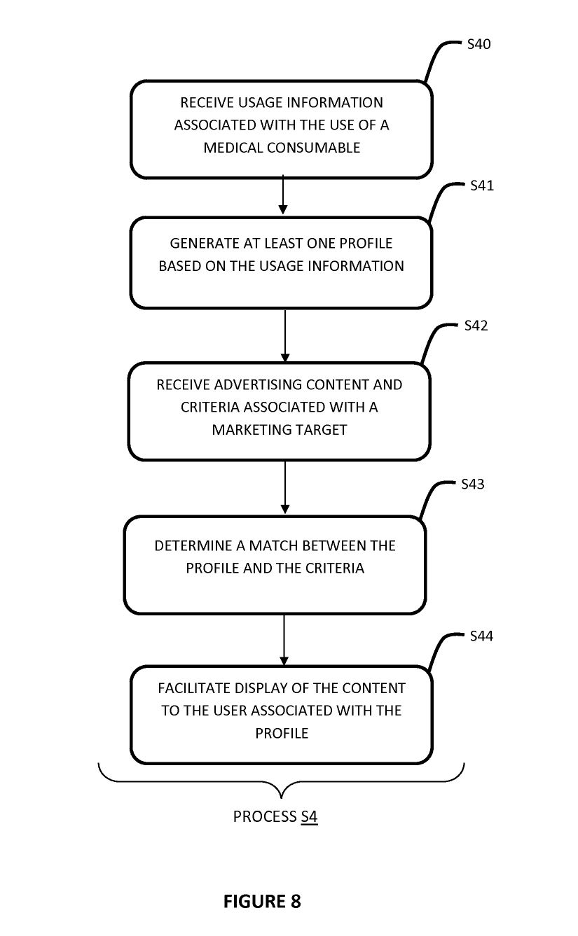

An exemplary process S4 for sending targeted advertising to a marketing target will now be described with reference to FIG. 8. First the Advertising Manager 41 receives usage information associated with the use of a medical consumable (Step S40). The usage information may be sent automatically or upon request. In one embodiment, the Advertising Manager 41 is one of the subscribers to the usage reports.

Next the Advertising Manager 41 generates at least one profile based on the usage information (Step S41). The profile may be a profile of a marketing target including any combination or subset of the usage information. The Advertising Manager 41 may store any number of profiles in memory.

Upon receiving advertising content and criteria associated with an intended marketing target (Step 42), the Advertising Manager 41 determines a match between at least one of the stored profiles and the criteria. In one embodiment, a match is determined if some threshold is met (e.g., a 60% match between the profile and the criteria). For some number of the matches, the advertising content is transmitted to the medical setting having the associated profile and displayed to a user associated with the profile (Step S44). The advertising content may be sent by e-mail, a communication protocol built into the Medical Consumable Tracking System 40, etc.

In one embodiment the advertising content is sent to the terminals in the medical setting that are used to collect the information about the medical consumables and displayed thereon.

Other features in the system will provide decision makers with timely information to make more informed decisions, including: 1) direct communication modalities (or instant messaging) between physicians, hospitals, payers, and suppliers; 2) supplier advertisement slots to market products; 3) easy-to-use product comparison charts (illustrating the features and benefits, scientific data, and health economic information, patent life-cycle, product pipeline); 4) product usage feedback; 5) newsfeeds from various sites, including the manufacturer, CMS, or FDA website on recently approved, recalled, or pipeline products; 6) conflict of interest information (e.g., sunshine laws); and 7) access to electronic medical records (EMR) to leverage product/patient data for case presentations, peer-reviewed publications, product usage for payers, providers, and suppliers as well as aggregate data for manufacturers to develop white papers to use as selling tools.

Embodiments of the present invention will also provide a sophisticated “professional network” providing specific, real-time information on a physician's profile without concealing confidential supplier data/information. The “network” will include those physicians that are operating in hospitals that are utilizing the exchange, and will have a feature whereby direct communication can be achieved between the physician and various third parties. In addition, third parties will be able to more effectively locate physicians while having a better understanding of their experience/specialty with various devices or drugs.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved.

Additionally, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A system for tracking resource usage in a medical setting, the system comprising:
a terminal that is configured to receive information about at least one medical consumable from an input device; and
an inventory tracker that is configured to receive information about the at least one medical consumable from the terminal, update inventory information about the at least one medical consumable stored in computer readable memory, and generate an inventory report based on the inventory information; and
an analytics engine that is configured to receive the inventory information, process the inventory information to generate usage information about the at least one medical consumable, and generate a usage report based on the usage information.

2. The system of claim 1, wherein the information about the at least one medical consumable comprises at least one or more of manufacturer identity, the item name, item size, date of arrival, date of use, date of expiration, site usage, prescribing physician, facility name, and combinations thereof.

3. The system of claim 1, wherein the usage information is at least one of product specific, facility specific, or physician specific.

4. The system of claim 1, wherein the usage information comprises at least one of a forecasted demand for the medical consumable, historical demand for the medical consumable, a number of medical consumables used during a defined period, a number of medical consumable expired during a defined period, a number of medical consumables sold during a defined period, and combinations thereof.

5. The system of claim 1, wherein the usage report is a graphical representation of the usage information.

6. The system of claim 1, wherein the analytics engine is configured to receive category usage information about the at least one medical consumable and generate the usage report based at least in part on the category usage information.

7. The system of claim 1, wherein the input device comprises at least one of a smartphone, tablet, desktop, radio frequency identifier reader, barcode reader, or combinations thereof.

8. The system of claim 1, further comprising an exchange that is configured to list the at least one medical consumable for consumption by a third party based at least in part on information received from the inventory tracker.

9. The system of claim 8, wherein the inventory tracker updates inventory information about the at least one medical consumable based on a notice from the exchange indicating a transaction associated with the medical consumable.

10. The system of claim 1, wherein the analytics engine makes available the usage information to one or more subscribers.

11. The system of claim 10, wherein the subscribers may be one or more of a manufacturer, a distributor, a hospital administrator, a physician, and a financial analyst.

12. The system of claim 1, further comprising an advertisement manager that is configured to receive the usage information, receive advertising content, and transmit the advertising content to one or more marketing targets based on criteria provided by an advertiser and associated with one or more profiles generated from the usage information.

13. The system of claim 11, wherein one or more of the inventory tracker and the terminal is configured to present the advertising content.

14. A computer implemented method of for tracking resource usage in a medical setting, the method comprising:
collecting information about at least one medical consumable;
updating inventory information stored in computer readable memory about the at least one medical consumable based on the collected information;
generate, by a computer, usage information about the at least one medical consumable based on the inventory information; and
generate, by a computer, a usage report based on the usage information.

15. The computer implemented method of claim 14, wherein the information about the at least one medical consumable comprises at least one or more of manufacturer identity, resource name, resource size, date of arrival, date of use, date of expiration, site usage, prescribing physician, facility name, and combinations thereof.

16. The computer implemented method of claim 14, wherein the usage information is at least one of product specific, facility specific, or physician specific.

17. The computer implemented method of claim 14, wherein the usage information comprises at least one of a forecasted demand for the medical consumable, historical demand for the medical consumable, a number of medical consumables used during a defined period, a number of medical consumables expired during a defined period, a number of medical consumables sold during a defined period, and combinations thereof.

18. The computer implemented method of claim 14, wherein the usage report is a graphical representation of the usage information.

19. The computer implemented method of claim 14, the method further comprising receiving category usage information about the at least one medical consumable and generate the usage report based at least in part on the category usage information.

20. The computer implemented method of claim 14, the method further comprising making the usage report available to one or more subscribers.

21. A computer implemented method for providing targeted advertising in a medical setting, the method comprising:
receiving usage information associated with at least one user's use of at least one medical consumable;
generating, by a computer, at least one profile based on the usage information and storing the profile in computer readable memory;
receiving advertising content and criteria associated with a marketing target; and
facilitating display of the content to one or more users based on a match, determined at least in part by a computer, between the profile associated with the user and the criteria.
